(19) United States
(12) Patent Application Publication
(10) Pub. No.: US 2012/0196053 A1
(43) Pub. Date: Aug. 2, 2012

(54) METHODS FOR CREATING AN ELECTRICALLY CONDUCTIVE TRANSPARENT STRUCTURE

(76) Inventors: Richard COULL, Clonsilla (IE); Vittorio Scardaci, Dublin (IE); Kevin Dooley, Blessington (IE)

(21) Appl. No.: 13/015,835

(22) Filed: Jan. 28, 2011

(51) Int. Cl. B05D 5/12; B06B 1/00

(52) U.S. Cl. 427/600; 427/108; 427/109; 427/110

(57) ABSTRACT

Creating an electrically conductive transparent structure. Liquid droplets comprising electrically conductive nanomaterial are deposited randomly onto a surface of a supporting substrate at a desired density to form an electrically conductive transparent network wherein the droplets are released from an applicator. A rate of drying of the liquid is controlled such that the liquid is able to evaporate without substantially damaging the supporting substrate.

### FIELD

Embodiments of the present invention relate generally to creating an electrically conductive transparent thin film.

### BACKGROUND

Modern technology provides for techniques used to create nanomaterials including thin films. Such thin films may have various properties relating to optical and electrical performance and may be used in display technologies. Wet printing is one technique that has been used to create thin films. Wet printing may result in a bias of the alignment of high aspect ratio nanoparticles which results in non-optimal performance. This also may lead to unreliable electrical performance of the thin film.

### BRIEF DESCRIPTION OF THE DRAWINGS

FIG. 1 illustrates a block diagram of an environment for creating an electrically conductive transparent thin film in accordance with embodiments of the present technology.

FIG. 2 illustrates a flowchart of an example method for creating an electrically conductive transparent structure in accordance with embodiments of the present technology.

FIG. 3 illustrates a flowchart of an example method for creating an electrically conductive transparent structure in accordance with embodiments of the present technology.

The drawings referred to in this description of embodiments should be understood as not being drawn to scale except if specifically noted.

### DESCRIPTION OF EMBODIMENTS

Reference will now be made in detail to various embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “forming”, “controlling”, “depositing,” “evaporating,” “generating,” “repeating,” or the like, refer to the actions and processes of creating a nanostructured thin film in accordance with various embodiments of the present technology.

### Overview of Discussion

Embodiments of the present technology comprise methods for creating an electrically conductive transparent structure. Such a structure may be employed in display technology including, but not limited to, flexible transparent display technology. One goal of the present technology is to maximize performance of a transparent conductor at a low cost. This includes employing a thin supporting substrate and depositing an electrically conductive yet transparent network on the surface of the substrate without damaging the substrate. In one embodiment, a method for controlling the dispersion and deposition of droplets is employed where the droplets are comprised of a liquid and a plurality of electrically conductive nanostructures. Such a method may employ droplet depositing techniques such as air atomized spray, ultrasonic atomized spray, or inkjet.

Embodiments of the present technology describes methods of controlling the deposition of nanomaterial based liquid dispersions, such that the finished film has minimal non-uniformity with maximized optical and electrical performance at minimal cost. For example, such films can be deposited onto flexible transparent polymer substrates at temperatures below 110 degrees centigrade.

In one embodiment, the temperature of the substrate is controlled such that the liquid in the droplets evaporates quickly without damaging the substrate. The result is an electrically conductive percolating network of nanostructures that are transparent and deposited with minimal non-uniformity. As a result embodiments of the present technology create a flexible structure that is well suited for use with a flexible substrate. Materials for the flexible substrate may include, but are not limited to, polyethylene terephthalate (PET).

### Embodiments for Creating an Electrically Conductive Transparent Structure

Embodiments of the present technology proposes an integrated method to improve the uniform distribution of electrically conducting nanomaterial particles in two dimensions from the micrometer to centimeter length scale across a substrate surface, using droplet deposition methods such as spray or inkjet. Such films can be used in applications requiring transparent conducting electrodes, such as the flat panel display market. These methods solve problems associated with poor optical and electrical performance, large area deposition (decimeter scale and above), high cost of these films due to inefficient distribution of nanoparticles, and/or high process temperatures that could degrade cheap transparent polymeric substrates.

When these solid nanoparticles are dispersed in a liquid, atomized via spray or inkjet processes, and directed at a transparent substrate (either flexible or rigid), they impinge on that substrate and the liquid component evaporates (either at ambient temperature or slightly above).

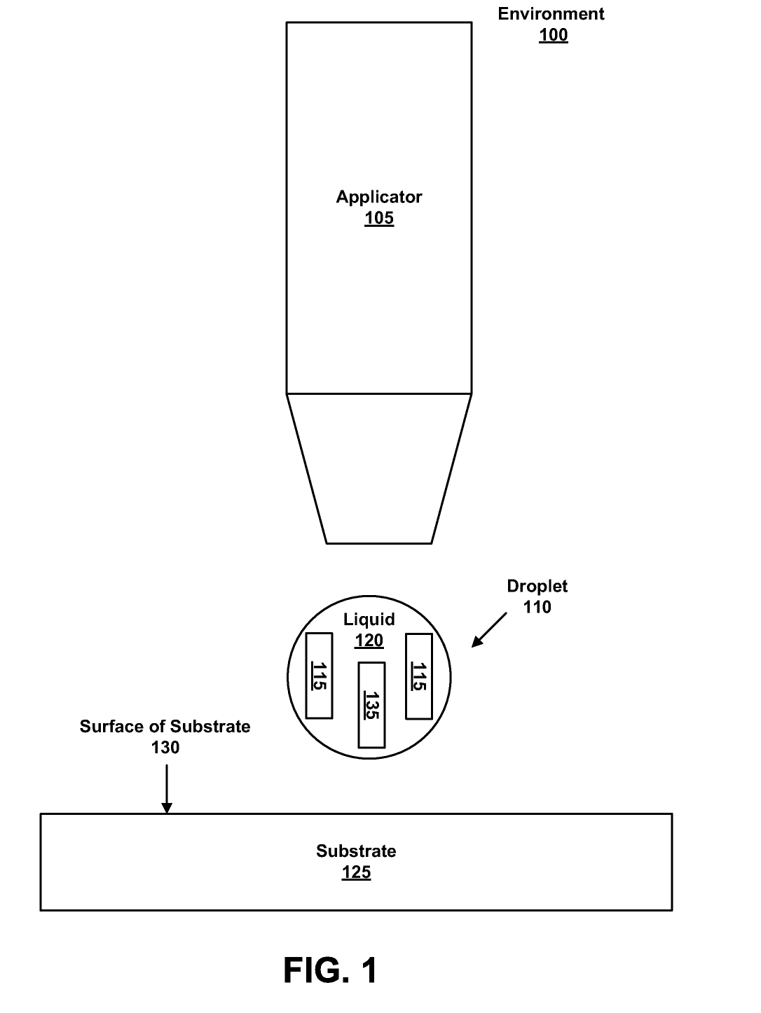

With reference now to FIG. 1, a block diagram of an environment for creating an electrically conductive transparent structure, in accordance with embodiments is shown. Environment 100 includes applicator 105, droplet 110, nanomaterial 115, liquid 120, substrate 125, surface of substrate 130, and dispersion agent 135. Environment 100 should not be construed to limit the present technology.

In one embodiment, applicator 105 is part of a larger system used for creating an electrically conductive transparent structure using droplet deposition methods. For example, a reservoir may be attached to applicator 105 and the reservoir contains a mixture of a liquid 120 and nanomaterial 115. The mixture may be used by applicator 105 to create droplets such as droplet 110. In one embodiment, a plurality of applicators 105 are employed for creating an electrically conductive transparent structure.

In one embodiment, applicator 105 is employed in such a way to control the size of droplet 110 and the rate of flow of droplet 110 as it leaves applicator 105. It should be appreciated that environment 100 is drawn only depicting one droplet 110, but in practice there may be a plurality of droplets that are formed by applicator 105. Such droplets may be similar in size or different. Such droplets may also contain different numbers of nanomaterial 115. Droplet 110 is shown to contain a quantity of two of nanomaterial 115. In one embodiment, the droplets pass from applicator 105 to substrate 125. In one embodiment, the deposition of droplet 110 onto surface of substrate 130 can be controlled by generating movement between applicator 105 and substrate 125. It should be appreciated that either applicator 105 or substrate 125 may be moved relative to the other to generate such movement.

In one embodiment, applicator 105 is moved passed substrate 125 multiple times, each time ejecting droplets to be deposited on surface of substrate 130. In one embodiment, time is allowed between each pass of applicator 105 over substrate 125 to allow the deposited droplet to dry. By passing applicator 105 over substrate 125 multiple times, more nanomaterial 115 is able to be deposited on the surface of substrate 130. In one embodiment, the nanomaterial 115 forms an electrically conductive network along the surface of substrate 130. In one embodiment, nanomaterial 115 forms an electrically conductive transparent structure after only one pass of applicator 105 over surface of substrate 130.

In one embodiment, the technique results with a complete network of nanowires spread over the substrate; however, the technique may begin by laying down only a small portion of the nanowires which are dispersed over the substrate and then dried, subsequent to the next coat being applied with random droplet location, and then dried on top. In this way, very thin layers of nanowires can be added on each spray coating pass sequentially with a high degree of control.

In one embodiment, applicator 105 does not contact substrate 125 as it deposits droplets onto surface of substrate 130. In such an embodiment, droplets exit applicator 105 and pass through the air and onto surface of substrate 130. The rate of flow of the droplets may be controlled using a variety of techniques at applicator 105 including but not limited to, air pressure in applicator 105, liquid pressure in applicator 105, etc.

In one embodiment, droplet 110 is composed of liquid 120 and nanomaterial 115. Liquid 120 is formed such that all or a portion of liquid 120 may evaporate on surface of substrate 130 at a temperature that will not damage substrate 125. In one embodiment, liquid 120 is water. For example, a portion of liquid 120, which is composed of water, may evaporate at temperatures at or slightly above ambient temperature. Thus nanomaterial 115 may be deposited on surface of substrate 130 at a temperature that will not damage substrate 125.

In one embodiment, droplet 110 is formed with dispersion agent 135. Dispersion agent 135 may be a surfactant employed to disperse the nanomaterial 115 within droplet 110. For example, dispersion agent 135 may be sodium dodecyl sulfate. In one embodiment, dispersing agent 135 is employed when nanomaterial 115 is a carbon nanotube. Thus the dispersion agent 135 allow nanomaterial 115 to be distributed evenly and uniformly across the surface of substrate 130.

In one embodiment, liquid 120 is water mixed with another solvent such as alcohol. Isopropanol is one example of a solvent that may be mixed with water. Once liquid 120 or a portion of liquid 120 has evaporated off the surface of substrate 130, the nanomaterial 115 is left behind. In one embodiment, the nanomaterial 115 that is left behind on the surface of substrate 130 is such a manner that the nanomaterial 115 forms an electrically conductive network on surface of substrate 130. The nanomaterial may be formed thin enough that it is transparent after forming the electrically conductive network on surface of substrate 130. In one embodiment, the electrically conductive network on surface of substrate 130 is flexible while maintaining electrical conductivity.

Embodiments of the present technology forms droplet 110 small enough such that there is a lower probability of droplets agglomerating when wet on surface of substrate 130 during spray processing. This allows droplet 110 to shrink evenly whilst evaporating liquid 120.

In one embodiment, an air atomized spray technique is employed with applicator 105 to deposit droplet 110 onto surface of substrate 130. Air atomized spray is a process in which a liquid is entrained into a high velocity air stream. In one embodiment, the droplets created can range in size across 10's to 100's microns diameter. Factors which effect droplet size and size range include liquid flow rate, air pressure/velocity at mixing point, liquid viscosity and liquid surface tension.

In one embodiment, an ultrasonic atomized spray technique is employed with applicator 105 to deposit droplet 110 onto surface of substrate 130. Ultrasonic atomized spray is a process whereby a liquid is fed into a resonating nozzle that is vibrating at ultrasonic frequencies. In one embodiment, the typical range is that above the range of human hearing which is greater than 25 kilohertz. Waves are formed on the surface of the liquid at the resonating surface, and droplets can be formed when the power of the resonating waves exceed the liquid dependent threshold. In one embodiment, the droplets created can range in size across 10's microns diameter and can be directionally controlled using currents of air/gas. Factors which affect liquid droplet size include liquid surface tension, liquid density and frequency of resonation.

In one embodiment, an inkjet technique is employed with applicator 105 to deposit droplet 110 onto surface of substrate 130. Inkjet is a process where liquid is fed into a chamber that contains either a thermally actuated trigger (Thermal Inkjet—TIJ) or a piezoelectrically actuated trigger (Piezo Inkjet—PIJ), inline with an ejection orifice. Actuation of the trigger forces a small volume (typically nanolitres or picolitres) of liquid through the orifice, producing a droplet traveling at velocity. In one embodiment, the droplets created can range in size across sub to 10's microns diameter. Factors which affect liquid droplet size include liquid surface tension, liquid density, liquid viscosity, firing frequency, firing power and orifice diameter.

Using the techniques of the present technology prevents some of the disadvantages of prior techniques. For example, previous techniques for creating electrically conductive thin films often resulted in what is known as “coffee staining” effect. This effect occurs if a liquid suspension containing a solid component is allowed to dry on a substrate. This is an effect which occurs due to different rates of solvent evaporation between the edge and centre/top of the droplet. The result of the coffee staining effect is that the nanomaterial is not uniformly distributed.

Embodiments of the present technology dramatically reduce the coffee staining effect by controlling the size of the droplets and the deposition of the droplets on the surface of substrate 130. Additionally, by repeating the deposition multiple times (e.g. passing applicator 105 over substrate 125 multiple times) and evaporating a portion of liquid 120 after each pass, the droplets are prevented from combining with or impinging upon one another. This results in a more uniform distribution of the nanomaterial across the surface of substrate 130. Additionally, techniques of the present technology may be compatible with roll to roll processes or patterning techniques.

It should be appreciated nanomaterial 115 may composed of a variety of material and shapes including nanowires. In one embodiment, nanomaterial 115 is composed of silver nanowires or AgNW. In one embodiment, the diameter of the AgNW is ˜80 nm. In one embodiment, nanomaterial 115 is composed of single walled carbon nanotubes. It should be appreciated that the present technology is not limited to a particular type of nanomaterial and may employ metallic and metal oxide semi conducting nanowire, graphene and carbon nanotubes.

It should be appreciated that substrate 125 may be composed of a variety of material including materials that are transparent and flexible. In one embodiment, substrate 125 is composed of a polymer. Two examples of such a polymer are polyethylene terephthalate (PET) and polyethylene naphthalate (PEN).

Thus the resulting structure may be composed of substrate 125 as well as the resulting network of nanomaterial. Such a structure may be both transparent and flexible.

Thus, embodiments of the present technology create low cost and high performance thin films. Additionally these thin films may be electrically conductive, flexible and transparent.

### Operation

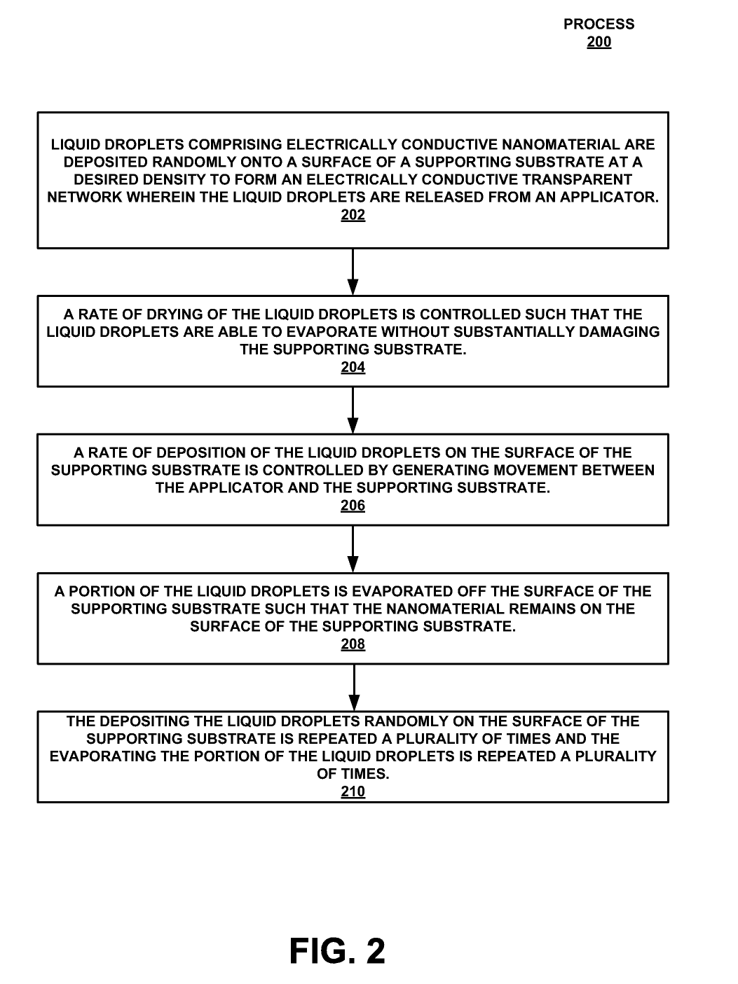

FIG. 2 is a flowchart illustrating process 200 for creating an electrically conductive transparent thin film, in accordance with one embodiment of the present invention. It should be appreciated that the steps of process 200 may not need to be executed in the order they are listed in. Additionally, embodiments of the present technology do not require that all of the steps of process 200 be executed to create an electrically conductive transparent thin film.

At 202, liquid droplets comprising electrically conductive nanomaterial are deposited randomly onto a surface of a supporting substrate at a desired density to form an electrically conductive transparent network wherein the liquid droplets are released from an applicator. Such a liquid may be comprised of water, a solvent, alcohol, a dispersing agent or any combination thereof. In one embodiment, the electrically conductive nanomaterial is silver nanowires. It should be appreciated that other nanomaterial may be used. In one embodiment, the droplets are formed with a dispersing agent such that the dispersing agent disperses the nanomaterial evenly in the droplet.

A desired density allows for the droplets to be deposited on the surface of a substrate with minimal non-uniformity that ultimately results in an electrically conductive network that is thin enough to be flexible. It should be appreciated that various techniques may be employed to control the deposition, including, but not limited to air atomization, inkjet, and ultrasonic atomized spray.

At 204, a rate of drying of the liquid droplets is controlled such that the liquid droplets able to evaporate without substantially damaging the supporting substrate. In one embodiment, the rate of drying is controlled by controlling the temperature. The temperature may be just above ambient temperatures in the process that are just warm enough for a portion of the liquid to evaporate. In one embodiment, the temperature is below 110 degrees centigrade. In one embodiment, the rate of drying is controlled by controlling the pressure at which the liquid droplets are released from the applicator.

In one embodiment, the network of nanomaterials is a percolating network. In one embodiment, the droplets are deposited on the surface of the substrate without the applicator contacting the substrate. In other words, the droplets leave the applicator, pass through the air and are deposited on the substrate. In one embodiment, the droplets are deposited such that the droplets do not combine with other droplets on the substrate. In one embodiment, the depositing the droplets randomly on the surface of the supporting substrate further comprises depositing the droplets such that the droplets are distributed uniformly on the surface of the supporting substrate. In one embodiment, the depositing the droplets randomly on the surface of the supporting substrate further comprises depositing the droplets on the surface of the supporting substrate without allowing the droplets to group together more closely on a first portion of the substrate relative to a second portion of the substrate.

At 206, a rate of deposition of the liquid droplets on the surface of the supporting substrate is controlled by generating movement between the applicator and the supporting substrate.

At 208, a portion of the liquid droplets is evaporated off the surface of the supporting substrate such that the nanomaterial remains on the surface of the supporting substrate. Thus the nanomaterial is left behind on the substrate with minimal non-uniformity, for example the “coffee stain” effect is avoided.

It should be appreciated that either the applicator or the supporting substrate may be moved. It should also be appreciated that the method may be accomplished with more than one applicator. In one embodiment, a rate of deposition of the droplets on the supporting substrate is controlled by controlling the liquid flow rate of the droplets out of the applicator.

At 210, the depositing the liquid droplets randomly on the surface of the supporting substrate a plurality of times and repeating the evaporating the portion of the liquid droplets is repeated a plurality of times. In one embodiment, the depositing the droplets and the evaporating a portion of the liquid is repeated in the range of 20-50 times.

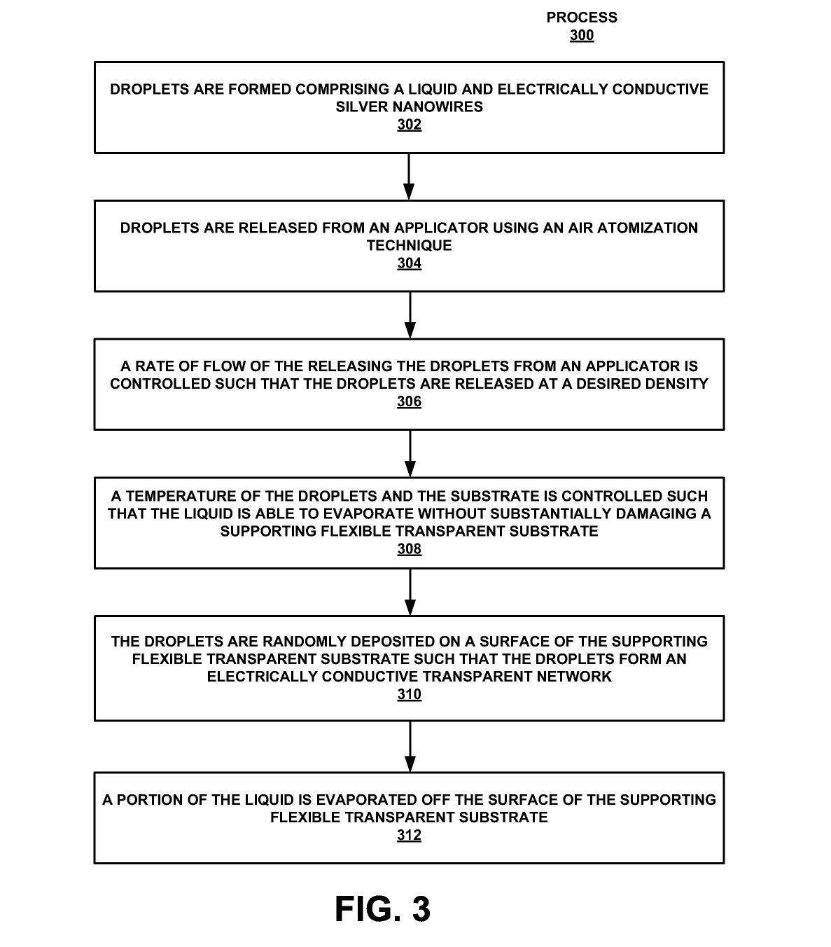

FIG. 3 is a flowchart illustrating process 300 for creating an electrically conductive transparent thin film, in accordance with one embodiment of the present invention. It should be appreciated that the steps of process 300 may not need to be executed in the order they are listed in. Additionally, embodiments of the present technology do not require that all of the steps of process 300 be executed to create an electrically conductive transparent thin film.

At 302, droplets are formed comprising a liquid and electrically conductive silver nanowires.

At 304, droplets are released from an applicator using an air atomization technique.

At 306, a rate of flow of the releasing the droplets from an applicator is controlled such that the droplets are released at a desired density.

At 308, a temperature of the droplets and the substrate is controlled such that the liquid is able to evaporate without substantially damaging a supporting flexible transparent substrate.

At 310, the droplets are randomly deposited on a surface of the supporting flexible transparent substrate such that the droplets form an electrically conductive transparent network.

At 312, a portion of the liquid is evaporated off the surface of the supporting flexible transparent substrate.

What is claimed is:

1. A method for creating an electrically conductive transparent structure, said method comprising:
depositing liquid droplets comprising electrically conductive nanomaterial randomly onto a surface of a supporting substrate at a desired density to form an electrically conductive transparent network wherein said liquid droplets are released from an applicator; and
controlling a rate of drying of said liquid droplets such that said liquid droplets are able to evaporate without substantially damaging said supporting substrate.

2. The method of claim 1 wherein said depositing said liquid droplets randomly on said surface of said supporting substrate forms a flexible electrically conductive transparent structure.

3. The method of claim 1 wherein said depositing said liquid droplets is accomplished using an air atomization technique.

4. The method of claim 1 wherein said depositing said liquid droplets is accomplished using an inkjet technique.

5. The method of claim 1 wherein said depositing said liquid droplets is accomplished using an ultrasonic atomized spray technique.

6. The method of claim 1 wherein said nanomaterial is silver nanowires.

7. The method of claim 1 wherein said liquid droplets further comprise a dispersing agent such that said dispersing agent disperses said nanomaterial evenly in said liquid droplets.

8. The method of claim 1 wherein said depositing said liquid droplets is accomplished without said applicator contacting said surface of said supporting substrate.

9. The method of claim 1 wherein said depositing said liquid droplets comprises:
controlling a rate of deposition of said liquid droplets on said surface of said supporting substrate by generating movement between said applicator and said supporting substrate.

10. The method of claim 1 further comprising:
evaporating a portion of said liquid droplets off said surface of said supporting substrate such that said nanomaterial remains on said surface of said supporting substrate.

11. The method of claim 10, further comprising:
repeating said depositing said liquid droplets randomly on said surface of said supporting substrate a plurality of times and repeating said evaporating said portion of said liquid droplets a plurality of times.

12. The method of claim 1 wherein said depositing said liquid droplets randomly on said surface of said supporting substrate further comprises depositing said liquid droplets such that said liquid droplets are distributed uniformly on said surface of said supporting substrate.

13. The method of claim 1 wherein said depositing said liquid droplets randomly on said surface of said supporting substrate further comprises depositing said liquid droplets on said surface of said supporting substrate without allowing said liquid droplets to group together more closely on a first portion of said substrate relative to a second portion of said substrate.

14. A method for creating an electrically conductive transparent structure, said method comprising:
forming droplets comprising a liquid and electrically conductive nanomaterial;
controlling a rate of flow of said droplets released from an applicator such that said droplets are released at a desired density;
controlling a temperature of said droplets and said substrate such that said liquid is able to evaporate without substantially damaging a supporting substrate;
depositing said droplets randomly on a surface of said supporting substrate;
evaporating a portion of said liquid off said surface of said supporting substrate; and
repeating said depositing said droplets randomly on said surface of said supporting substrate a plurality of times and repeating said evaporating said portion of said liquid a plurality of times such that said droplets form an electrically conductive transparent network.

15. The method of claim 14 wherein said depositing said droplets randomly on said surface of said supporting substrate and said allowing said portion of said liquid to evaporate forms a flexible electrically conductive transparent structure.

16. The method of claim 14 wherein said controlling said rate of flow is accomplished using an air atomization technique.

17. The method of claim 14 wherein said depositing said droplets is accomplished without said applicator contacting said supporting substrate.

18. The method of claim 14 wherein said depositing said droplets further comprises:
controlling a rate of deposition of said droplets on said supporting substrate by generating movement between said applicator and said supporting substrate.

19. The method of claim 14, further comprising:
repeating said depositing said droplets randomly on said surface of said supporting substrate a plurality of times and repeating said allowing said portion of said liquid to evaporate a plurality of times.

20. A method for creating an electrically conductive transparent structure, said method comprising:
forming droplets comprising a liquid and electrically conductive silver nanomaterial;
releasing droplets from an applicator using an air atomization technique;
controlling a rate of flow of said releasing said droplets from an applicator such that said droplets are released at a desired density;
controlling a temperature of said droplets and said substrate such that said liquid is able to evaporate without substantially damaging a supporting flexible transparent substrate;
depositing said droplets randomly on a surface of said supporting flexible transparent substrate such that said droplets form an electrically conductive transparent network;
evaporating a portion of said liquid off said surface of said supporting flexible transparent substrate.
